(19) United States
(12) Patent Application Publication
(10) Pub. No.: US 2006/0233602 A1
(43) Pub. Date: Oct. 19, 2006

(54) Methods and apparatus for connector

(75) Inventor: Paul A. Merems, Tucson, AZ (US)

Correspondence Address: NOBLITT & GILMORE, LLC., 4800 NORTH SCOTTSDALE ROAD, SUITE 6000, SCOTTSDALE, AZ, 85251, US

(73) Assignee: RAYTHEON COMPANY

(21) Appl. No.: 11/106,295

(22) Filed: Apr. 14, 2005

(51) Int. Cl. B25G 3/18

(52) U.S. Cl. 403/322.2

(57) ABSTRACT

A method and apparatus for a connector according to various aspects of the present invention operates in conjunction with a connector having a surface with a hole defined therethrough and a protruder aligned with the hole. A rotary mover engages the protruder and moves the protruder through the hole according to rotation of the rotary mover.

### FIELD OF THE INVENTION

The invention relates to methods and apparatus for selectably connecting and disconnecting objects.

### BACKGROUND OF THE INVENTION

Connectors find applications in virtually every aspect of technology, and come in a nearly infinite variety of sizes, shapes, configurations, and levels of complexity. Some connectors permanently fasten objects together, such as rivets and welds, whereas others are releasable to allow the objects to be selectably separated, like clothespins and screw-on caps. In many applications, however, sturdy, small, and quickly realeasable connectors are required. Conventional connectors, such as linear ball lock connectors, may be sturdy, but may not release easily or operate within a confined area. Linear ball lock connectors may also include several parts, contributing weight, cost, and complexity.

### SUMMARY OF THE INVENTION

A method and apparatus for a connector according to various aspects of the present invention operates in conjunction with a connector having a surface with a hole defined therethrough and a protruder aligned with the hole. A rotary mover engages the protruder and moves the protruder through the hole according to rotation of the rotary mover.

### BRIEF DESCRIPTION OF THE DRAWING

A more complete understanding of the present invention may be derived by referring to the detailed description when considered in connection with the following illustrative figures. In the following figures, like reference numbers refer to similar elements and steps.

FIG. 1 is a perspective view of a connector according to various aspects of the present invention;

FIGS. 2 and 3 are an exploded view and a perspective view, respectively, of the connector;

FIGS. 4A-B are a cross-section side view and an end view, respectively, of the connector connecting two members; and

FIGS. 5A-B are a cross-section side view and an end view, respectively, of the connector releasing the two members.

Elements and steps in the figures are illustrated for simplicity and clarity and have not necessarily been rendered according to any particular sequence. For example, steps that may be performed concurrently or in different order are illustrated in the figures to improve understanding of embodiments of the present invention.

### DETAILED DESCRIPTION OF EXEMPLARY EMBODIMENTS

The present invention is described partly in terms of functional components and various processing steps. Such functional components may be realized by any number of components configured to perform the specified functions and achieve the various results. For example, the present invention may employ various elements, materials, actuators, protruders, and the like, which may carry out a variety of functions. In addition, the present invention may be practiced in conjunction with any number of applications and environments, and the systems described are merely exemplary applications for the invention. Further, the present invention may employ any number of conventional techniques for manufacturing, assembling, mounting, and the like.

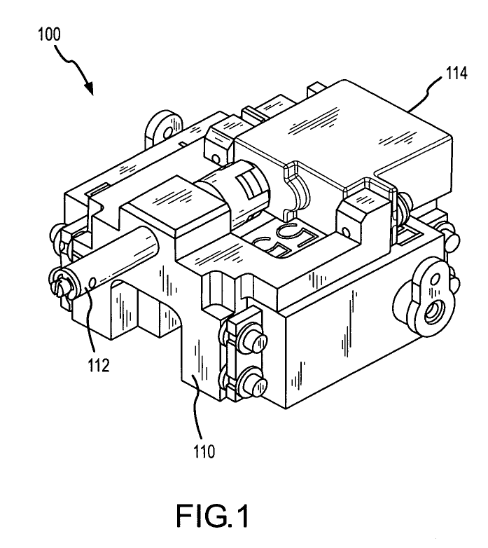

A connector for selectably connecting and disconnecting may be implemented in conjunction with two or more objects to be connected and disconnected. Referring now to FIG. 1, a selectably releasing assembly 100 according to various aspects of the present invention comprises a first member 110, a second member (not shown), a connector 112, and an actuator 114. The connector 112 connects the first member 110 to the second member. The actuator 114 controls the operation of the connector 112. The members may comprise any two objects to be selectably connected. For example, the members may comprise a housing and a cover, a mount and a retaining mechanism, a floor and a machine, a fuselage and a missile, or any other two or more objects. In the present embodiment, the first member 110 comprises a mounting structure, such as a building, airframe, or fuselage, and the second member comprises a retaining system for holding another object or multiple objects in place. When released, the retaining system disconnects from the mounting structure and the retained objects may move.

The actuator 114 controls the connector 112 to connect or disconnect the members. The actuator 114 may comprise any suitable system for controlling the operation of the connector 112. For example, in the present embodiment, the actuator 114 comprises a conventional drive device, such as a servo motor, gear/stepper motor, solenoid, or pneumatic cylinder, having a rotating shaft engaging the connector 112. The actuator 114 may respond to any suitable operation or signal, such as a physical force, electrical signal, optical signal, timer, radio frequency signal, or infrared signal.

The connector 112 selectably connects and disconnects the members. The connector 112 may comprise any appropriate system for releasably connecting the members. In the present embodiment, the connector 112 responds to the actuator 114 to control the connection or disconnection of the members, and may comprise any suitable system for releasably connecting the members in response to the actuator 114.

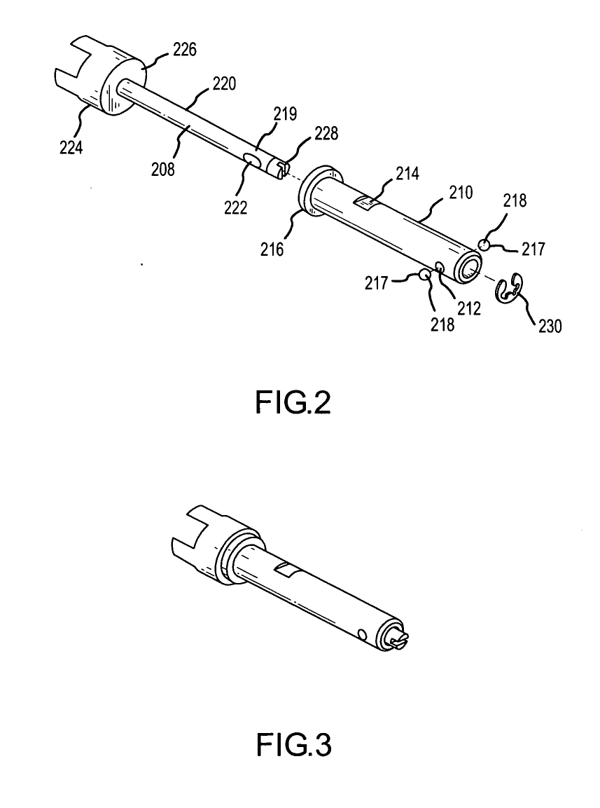

In one embodiment, referring to FIGS. 2 and 3, the connector 112 comprises a surface 208 having a hole 212, a protruder 217 aligned with the hole 212, and a rotary mover 219 engaging the protruder 217, wherein the rotary mover 219 moves the protruder 217 through the hole 212 according to rotation of the rotary mover 219. The members are attached to or otherwise engaged by the surface 208 having the hole 212 and the protruder 217. For example, the surface 208 having the hole 212 is implemented in an outer shaft 210. The outer shaft 210 suitably comprises a hollow cylinder formed of a rigid or resilient material having a cylindrical radial surface and two open ends. The outer shaft 210 may also be configured to be mounted on the first member 110. For example, the present outer shaft 210 includes a cavity or flat 214 for receiving a mounting bolt connected to the first member 110 to inhibit rotation and/or axial movement of the outer shaft 210 relative to the first member 110. The outer shaft 210 may include any other appropriate features, such as a bearing flange 216 against which the rotary mover 219 may rotate.

One or more holes 212 are formed in the outer shaft 210 to receive the protruders 217. Any number of holes 212 may be formed at any suitable position. In the present embodiment, the outer shaft 210 includes two opposing and aligned holes 212 formed near the distal end of the outer shaft 210. The axial location of the holes 212 may be selected to accommodate the second member between the holes 212 and the proximate end of the outer shaft 210. In addition, each hole 212 may be sized to accommodate at least a portion of the protruder 217.

The protruder 217 moves through the hole 212 formed in the surface 208 and selectably engages the second member. The protruder 217 may comprise any suitable protruder for extending through the hole 212 and engaging the second member, such as a rod, ball, hook, or the like. In the present embodiment, the protruder 217 comprises a ball 218 formed of a hard material, such as a ball bearing. Each ball 218 suitably has a diameter greater than the smallest diameter of the hole 212, which may be tapered or swaged to retain the ball 218. Each ball 218 is substantially aligned with one of the holes 212 and may be moved to partially extend through the hole 212 beyond the radial surface of the outer shaft 210 and engage the second member, or withdrawn within the outer shaft 210 so that less or no portion of the ball 218 extends beyond the radial surface 208 of the outer shaft 210.

The rotary mover 219 selectably moves the protruder 217 through the holes 212 to connect or disconnect the second member to or from the first member 110. In the present system, the rotary mover 219 may comprise any suitable system for moving the balls 218 through the holes 212. For example, the rotary mover 219 may be implemented in conjunction with an inner shaft 220 disposed within the outer shaft 210 such that the balls 218 move according to the rotation of the inner shaft 220 with respect to the outer shaft 210.

In the present embodiment, the inner shaft 220 includes an eccentric surface 222 formed near the distal end of the inner shaft 220 and substantially aligned with the balls 218 and holes 212. The eccentric surface 222 may comprise any suitable surface deviating from a circular surface around the rotating axis of the inner shaft 220 and/or the outer shaft 210, such as an elliptical surface, an oval surface, flats, or a circular surface having relief cuts. The eccentric surface 222 engages the balls 218 so that when the eccentric surface 222 rotates with respect to the balls 218 and holes 212, the balls 218 may be alternately forced partially out of the holes 212 or allowed to withdraw from the holes 212 into the outer shaft 210.

The inner shaft 220 may further include any suitable features or mechanisms for operating the connector 112. For example, the inner shaft 220 of the present embodiment includes a coupling 224 at the proximate end for connecting the inner shaft 220 to the actuator 114. The coupling 224 may comprise any suitable system for transferring movement from the actuator 114 to the inner shaft 220, such as a permanent or detachable coupling. The inner shaft 220 may also include a second bearing flange 226 against which the first bearing flange 216 may rotate.

At the distal end, the present inner shaft 220 includes a manual drive slot and/or position indicator 228 comprising a slot formed in the distal end. The slot may receive a flat surface, like a screwdriver, to allow manual adjustment of the inner shaft 220. The slot also serves as a visual indicator showing the current alignment of the eccentric surface 222 with respect to the outer shaft 210.

The connector 112 may comprise any additional items or features for operation. In the present embodiment, the connector 112 includes a fastener, such as a retainer clip 230, to fasten the outer shaft 210 to the inner shaft 220 to inhibit axial movement. The connector 112 may also include a biasing mechanism, such as a spring, configured to bias the first member 110 away from the second member when the connector 112 disconnects the members.

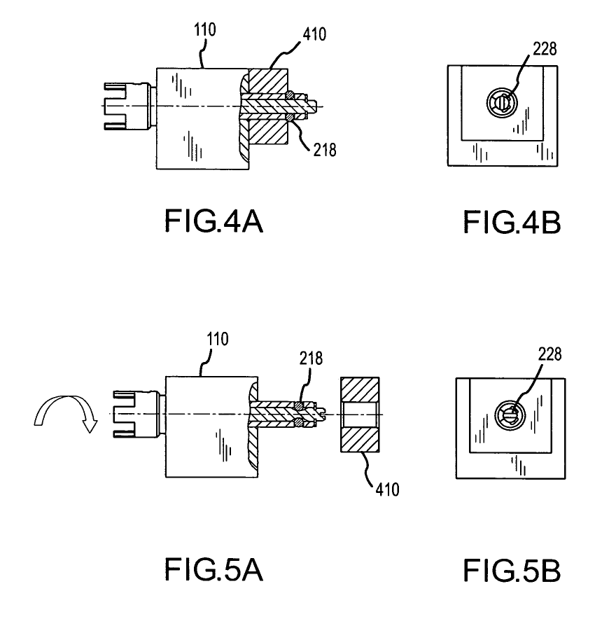

Referring to FIGS. 4A-B and 5A-B, the connector 112 may be initially configured to lock the first member 110 to the second member 410. The second member 410 may include a hole slightly larger than the outer diameter of the outer shaft 210 and through which the outer shaft 210 fits. In the locked position, the outer shaft 210 is inserted through the hole in the second member 410. The inner shaft 220 is then rotated so that the balls 218 are pushed outward by the eccentric surface 222 through the holes 212. The parts of the balls 218 that extend through the holes 212 secure the second member 410 in position, for example by engaging the side of the second member 410 or a cavity formed in the interior surface of the second member 410 hole that receives the outer shaft 210. In this position, the position indicator 228 is oriented vertically, indicating that the connector 112 is in the locked position.

To unlock the connector 112, a torque is applied to the inner shaft 220, such as via the coupling 224 or the distal slot, which turns the inner shaft 220 relative to the outer shaft 210. The inner shaft 220 turns the eccentric surface 222 relative to the balls 218. As the radius of the eccentric surface 220 under the balls 218 decreases, the balls 218 withdraw into the outer shaft 210, allowing the second member 410 to slide off the outer shaft 210. In the unlocked position, the position indicator 228 is oriented horizontally.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

The present invention has been described above with reference to a preferred embodiment. However, changes and modifications may be made to the preferred embodiment without departing from the scope of the present invention. These and other changes or modifications are intended to be included within the scope of the present invention.

1. A connector, comprising:
a surface having a hole defined therethrough;
a protruder aligned with the hole; and
a rotary mover engaging the protruder, wherein the rotary mover moves the protruder through the hole according to rotation of the rotary mover.

2. A connector according to claim 1, wherein the rotary mover comprises an eccentric surface engaging the protruder.

3. A connector according to claim 1, further comprising:
an outer shaft having a hollow interior, wherein the outer shaft includes the surface having the hole; and
the rotary mover includes an inner shaft rotatably disposed in the hollow interior of the outer shaft and engaging the protruder.

4. A connector according to claim 3, wherein the inner shaft includes an eccentric outer surface engaging the protruder.

5. A connector according to claim 1, wherein the protruder comprises a ball.

6. A releasable system for selectably releasing a first member from a second member, comprising:
a surface having a hole defined therethrough and attached to the first member;
a protruder aligned with the hole, wherein the protruder engages the second member when extended through the hole; and
a rotary mover configured to move the protruder through the hole such that the protruder engages or disengages the second member.

7. A releasable system according to claim 6, wherein the rotary mover comprises an eccentric surface engaging the protruder.

8. A releasable system according to claim 6, further comprising:
an outer shaft having a hollow interior, wherein the outer shaft includes the surface having the hole; and
the rotary mover includes an inner shaft rotatably disposed in the hollow interior of the outer shaft and engaging the protruder.

9. A releasable system according to claim 8, wherein the inner shaft includes an eccentric outer surface engaging the protruder.

10. A releasable system according to claim 6, wherein the protruder comprises a ball.

11. A releasable system for selectably releasing a first member from a second member, comprising:
an outer shaft attached to the first member, wherein the outer shaft has a hollow interior and a hole defined through a radial surface of the outer shaft;
a ball having a diameter greater than a diameter of the hole and seated in the hole, wherein an outer portion of the ball is configured to movably extend through the hole beyond the radial surface of the outer shaft and engage the second member;
an inner shaft rotatably disposed within the hollow interior of the outer shaft, wherein the inner shaft has an eccentric surface engaging the ball.

12. A method for releasing a second member from a first member, comprising:
providing a surface having a hole defined therethrough and attached to the first member;
providing a protruder extending through the hole and abutting the second member;
providing a rotary mover selectably biasing the protruder through the hole;
and rotating the rotary mover to relieve the biasing of the protruder through the hole.

13. A method according to claim 12, wherein the rotary mover comprises an eccentric surface engaging the protruder.

14. A method according to claim 12, further comprising:
an outer shaft having a hollow interior, wherein the outer shaft includes the surface having the hole; and
the rotary mover includes an inner shaft rotatably disposed in the hollow interior of the outer shaft and engaging the protruder.

15. A method according to claim 14, wherein the inner shaft includes an eccentric outer surface engaging the protruder.

16. A method according to claim 12, wherein the protruder comprises a ball.
